(19) United States
(12) Patent Application Publication
(10) Pub. No.: US 2026/0148899 A1
(43) Pub. Date: May 28, 2026

(54) MULTILAYER CERAMIC CAPACITOR AND METHOD OF MANUFACTURING THE SAME

(71) Applicant: SAMSUNG ELECTRO-MECHANICS CO., LTD., Suwon-si (KR)

(72) Inventors: Heesang Kang, Suwon-si (KR); Youjin Kim, Suwon-si (KR); Byoung Uk Ahn, Suwon-si (KR); Subeen Kim, Suwon-si (KR); Jinwoo Kim, Suwon-si (KR); Jeong Ryeol Kim, Suwon-si (KR)

(73) Assignee: SAMSUNG ELECTRO-MECHANICS CO., LTD., Suwon-si (KR)

(21) Appl. No.: 19/222,275

(22) Filed: May 29, 2025

(30) Foreign Application Priority Data
Nov. 25, 2024 (KR) 10-2024-0170038
Jan. 10, 2025 (KR) 10-2025-0004267

(51) Int. Cl. H01G 4/12; H01G 4/30

(52) U.S. Cl. CPC H01G 4/1281; H01G 4/30

(57) ABSTRACT

A multilayer ceramic capacitor including a capacitor body including a dielectric layer and an internal electrode layer, and an external electrode disposed on an outer surface of the capacitor body, wherein the dielectric layer comprises a plurality of dielectric grains, at least one of the plurality of dielectric grains has a core-shell structure including a core portion and a shell portion surrounding at least a portion of the core portion, the core portion comprises barium (Ba) and titanium (Ti), and the shell portion comprises calcium (Ca) or strontium (Sr), and zirconium (Zr).

### CROSS-REFERENCE TO RELATED APPLICATION

This application claims priority to and the benefit of Korean Patent Application No. 10-2025-0004267 filed in the Korean Intellectual Property Office on Jan. 10, 2025, and Korean Patent Application No. 10-2024-0170038 filed in the Korean Intellectual Property Office on Nov. 25, 2024, the entire contents of which are incorporated herein by reference.

### BACKGROUND

The present disclosure relates to a multilayer ceramic capacitor and a method of manufacturing the same.

As electronic components using a ceramic material, there are a capacitor, an inductor, a piezoelectric element, a varistor, a thermistor, and the like. Among ceramic electronic components, a multilayer ceramic capacitor (MLCC) may be used in various electronic devices due to advantages such as a small size, a high capacitance, an easy mounting feature, and the like.

For example, a multilayer ceramic capacitor (MLCC) may be used in a chip type condenser mounted on a board of several electronic products such as image devices, for example, liquid crystal displays (LCD), plasma display panels (PDP), or the like, computers, personal portable terminals, smartphones, and the like, to serve to charge or discharge electricity therein or therefrom.

In order to secure high functionality and stability in electrical and IT industrial devices, the need for miniaturization, high capacitance, and high guaranteed voltage of multilayer ceramic capacitors is expected to continuously increase.

### SUMMARY

The present disclosure provides a multilayer ceramic capacitor for a high-voltage having excellent temperature characteristics, withstand voltage characteristics, and DC bias characteristics.

Some embodiments of the present disclosure provide a method of manufacturing a multilayer ceramic capacitor.

Another embodiments of the present disclosure provide a multilayer ceramic capacitor including a capacitor body including a dielectric layer and an internal electrode layer, and an external electrode disposed on an outer surface of the capacitor body, wherein the dielectric layer comprises a plurality of dielectric grains, at least one of the plurality of dielectric grains has a core-shell structure including a core portion and a shell portion surrounding at least a portion of the core portion, the core portion includes barium (Ba) and titanium (Ti), the shell portion includes calcium (Ca) or strontium (Sr), and zirconium (Zr), and in a TEM-EDS (transmission electron microscopy-energy dispersive spectroscopy) line analysis for a long-axis straight section passing through a center of the dielectric grain having the core-shell structure, the core portion is a region in which zirconium (Zr) is less than about 3 parts by mole based on 100 parts by mole of titanium (Ti), and the shell portion is a region in which zirconium (Zr) is about 3 parts by mole or more based on 100 parts by mole of titanium (Ti).

The shell portion may include calcium (Ca) or strontium (Sr) in an amount of about 2.5 parts by mole to about 40 parts by mole based on 100 parts by mole of titanium (Ti).

The shell portion may include zirconium (Zr) in an amount of about 3 parts by mole to about 150 parts by mole based on 100 parts by mole of titanium (Ti).

The shell portion may include calcium (Ca) in an amount of about 2.5 parts by mole to about 40 parts by mole based on 100 parts by mole of titanium (Ti), and the shell portion may include zirconium (Zr) in an amount of about 3 parts by mole to about 150 parts by mole based on 100 parts by mole of titanium (Ti).

The shell portion may include strontium (Sr) in an amount of about 2.5 parts by mole to about 40 parts by mole based on 100 parts by mole of titanium (Ti), and the shell portion may include zirconium (Zr) in an amount of about 3 parts by mole to about 150 parts by mole based on 100 parts by mole of titanium (Ti).

The shell portion may further include a rare-earth element.

The rare-earth element may include an element with a larger ionic radius than yttrium (Y).

The rare-earth element may include at least one selected from the group consisting of dysprosium (Dy), gadolinium (Gd), lanthanum (La), and cerium (Ce).

The shell portion may include the rare-earth element in an amount of about 0.5 part by mole to about 10 parts by mole based on 100 parts by mole of titanium (Ti).

The shell portion may further include a transition metal.

The transition metal may include at least one selected from the group consisting of manganese (Mn), vanadium (V), and chromium (Cr).

The shell portion may further include a rare-earth element and a transition metal.

The shell portion may further include a rare-earth element including at least one selected from the group consisting of dysprosium (Dy), gadolinium (Gd), lanthanum (La), and cerium (Ce), and a transition metal including at least one selected from the group consisting of manganese (Mn), vanadium (V), and chromium (Cr).

The dielectric layer may further include a grain boundary disposed between the plurality of dielectric grains, and the grain boundary may include silicon (Si).

The grain boundary may include silicon (Si) in an amount of about 2.5 parts by mole to about 20 parts by mole based on 100 parts by mole of titanium (Ti).

The grain boundary may further include a rare-earth element.

The rare-earth element may include at least one selected from the group consisting of dysprosium (Dy), gadolinium (Gd), lanthanum (La), and cerium (Ce).

The grain boundary may include the rare-earth element in an amount of about 3 parts by mole to about 30 parts by mole based on 100 parts by mole of titanium (Ti).

A diameter of the core portion may be about 15% to about 85% of the diameter of the dielectric grain.

The number of dielectric grains having the core-shell structure may be about 5% to about 100% of the total number of dielectric grains present in the dielectric layer.

Another embodiments provide a method of manufacturing a multilayer ceramic capacitor, including preparing a dielectric slurry comprising main component powders including a barium titanate-based compound and a zirconium-based compound; manufacturing a dielectric green sheet from the dielectric slurry, and forming a conductive paste layer on a surface of the dielectric green sheet; manufacturing a dielectric green sheet stack by stacking a plurality of the dielectric green sheets on which the conductive paste layer is formed; manufacturing a capacitor body including a dielectric layer and an internal electrode layer by firing the dielectric green sheet stack; and forming an external electrode on an outer surface of the capacitor body, wherein the zirconium-based compound includes at least one selected from the group consisting of a compound containing Zr and Ca and a compound containing Zr and Sr, the dielectric layer includes a plurality of dielectric grains, at least one of the plurality of dielectric grains has a core-shell structure including a core portion and a shell portion surrounding at least a portion of the core portion, the core portion includes barium (Ba) and titanium (Ti), and the shell portion includes calcium (Ca) or strontium (Sr), and zirconium (Zr).

The main component powders may include a mixture of the barium titanate-based compound and the zirconium-based compound, or a composite in which the zirconium-based compound is coated on a surface of the barium titanate-based compound.

The zirconium-based compound may include at least one selected from the group consisting of CaZrO₃ and SrZrO₃.

The dielectric slurry may further include a secondary component powder including at least one selected from the group consisting of a silicon (Si)-containing compound, a rare-earth element-containing compound, and a transition metal-containing compound.

The rare-earth element-containing compound may include at least one selected from the group consisting of a dysprosium (Dy)-containing compound, a gadolinium (Gd)-containing compound, a lanthanum (La)-containing compound, and a cerium (Ce)-containing compound.

The transition metal-containing compound may include at least one selected from the group consisting of a manganese (Mn)-containing compound, a vanadium (V)-containing compound, and a chromium (Cr)-containing compound.

The secondary component powder may include at least one selected from the group consisting of the silicon (Si)-containing compound, the rare-earth element-containing compound, and the transition metal-containing compound. In some embodiments, the secondary powder may include the silicon (Si)-containing compound, the rare-earth element-containing compound, and the transition metal-containing compound.

The zirconium-based compound may be included in an amount of about 1 mol % to about 20 mol % based on a total amount of the barium titanate-based compound and the zirconium-based compound.

A multilayer ceramic capacitor according to an embodiment not only has high capacitance and high voltage characteristics, but also has excellent temperature characteristics, withstand voltage characteristics, and DC bias characteristics.

### BRIEF DESCRIPTION OF THE DRAWINGS

FIG. 1 is a perspective view showing a multilayer ceramic capacitor according to an embodiment.

FIG. 2 is a cross-sectional view of the multilayer ceramic capacitor taken along line I-I′ of FIG. 1.

FIG. 3 is a cross-sectional view of the multilayer ceramic capacitor taken along line II-II′ of FIG. 1.

FIG. 4 is an exploded perspective view illustrating the stacked structure by disassembling the capacitor body of FIG. 1.

FIG. 5 is a schematic view showing the dielectric layer according to an embodiment.

FIG. 6A to FIG. 6G are TEM-EDS (transmission electron microscopy-energy dispersive spectroscopy) mapping analysis images for the dielectric layer according to Example 3.

FIG. 7A and FIG. 7B are TEM-EDS (transmission electron microscopy-energy dispersive spectroscopy) line analysis images for the dielectric layer according to Example 3.

FIG. 8 is a graph showing a temperature coefficient of capacitance (TCC) of the multilayer ceramic capacitors according to Examples 1 to 4 and Comparative Example 1.

FIG. 9 is a graph showing STEP-IR characteristics of the multilayer ceramic capacitors according to Examples 2 to 5 and Comparative Example 1.

FIG. 10 is a graph showing DC bias characteristics of the multilayer ceramic capacitors according to Examples 1 to 5 and Comparative Example 1.

### DETAILED DESCRIPTION OF THE EMBODIMENTS

Hereinafter, the present disclosure will be described in detail with reference to the accompanying drawings, in which embodiments of the present disclosure are shown. The drawings and description are to be regarded as illustrative in nature and not restrictive. Like reference numerals designate like elements throughout the specification. In the accompanying drawings, some components are exaggerated, omitted, or schematically illustrated, and the size of each component does not entirely reflect the actual size.

The accompanying drawings are intended only to facilitate an understanding of the embodiments disclosed in this specification, and it is to be understood that the technical ideas disclosed herein are not limited by the accompanying drawings and include all modifications, equivalents, or substitutions that are within the range of the ideas and technology of the present disclosure.

Although terms of “first,” “second,” and the like are used to explain various components, the components are not limited to such terms. These terms are only used to distinguish one component from another component.

In addition, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is referred to as being “on” or “above” a reference element, it can be positioned above or below the reference element, and it is not necessarily referred to as being positioned “on” or “above” in a direction opposite to gravity.

Throughout the specification, the terms “comprise” or “have” are intended to specify the presence of stated features, integers, steps, operations, components, components or a combination thereof, but do not preclude the presence or addition of one or more other features, integers, steps, operations, components, components, and/or groups thereof. Therefore, unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Throughout the specification, the term “connected” does not mean only that two or more constituent components are directly connected, but may also mean that two or more constituent components are indirectly connected through another constituent component, that two or more components are electrically connected as well as physically connected, or that two or more constituent components are referred to by different names but are united by location or function.

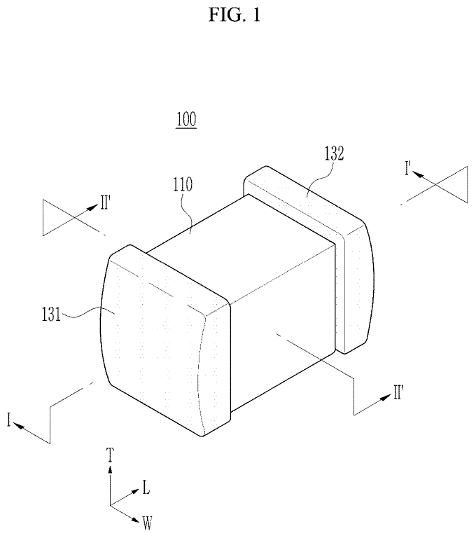

Hereinafter, a multilayer ceramic capacitor according to an embodiment will be described with reference to FIGS. 1 to 4.

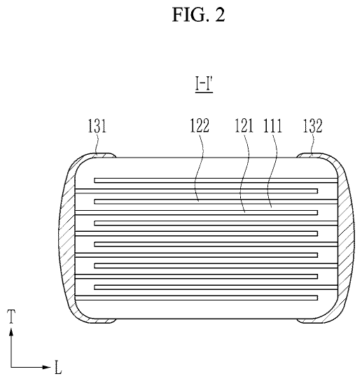

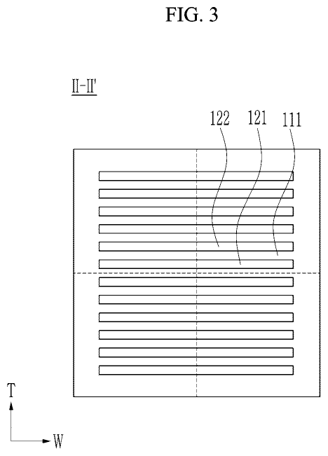

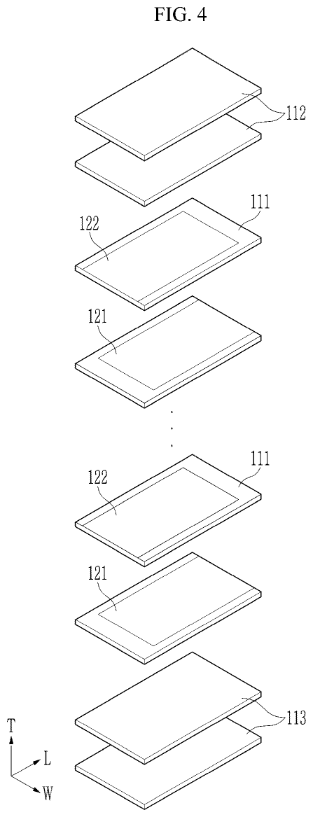

FIG. 1 is a perspective view showing a multilayer ceramic capacitor according to an embodiment, FIG. 2 is a cross-sectional view of the multilayer ceramic capacitor taken along line I-I′ of FIG. 1, FIG. 3 is a cross-sectional view of the multilayer ceramic capacitor taken along line II-II′ of FIG. 1, and FIG. 4 is an exploded perspective view illustrating the stacked structure by disassembling the capacitor body of FIG. 1.

The L-axis, W-axis, and T-axis shown in FIGS. 1 to 4 represent a length direction, a width direction, and a thickness direction of a capacitor body 110, respectively. Here, the thickness direction (T-axis direction) may be a direction perpendicular to the wide surface (major surface) of the sheet-shaped components, and may be used as the same concept as a stacking direction in which a dielectric layer 111 are stacked, for example. The length direction (L-axis direction) may be a direction extending parallel to the wide surface (major surface) of the sheet-shaped components, and may be approximately perpendicular to the thickness direction (T-axis direction). For example, the length direction (L-axis direction) may be the direction in which an external electrode 131 and a second external electrode 132 are positioned. The width direction (W-axis direction) may be a direction extending parallel to the wide surface (major surface) of the sheet-shaped components, and may be approximately perpendicular to the thickness direction (T-axis direction) and the length direction (L-axis direction). The length of the sheet-shaped components in the length direction (L-axis direction) may be longer than the length in the width direction (W-axis direction).

Referring to FIGS. 1 to 4, a multilayer ceramic capacitor according to some embodiments includes the capacitor body 110 and external electrodes 131 and 132 disposed on an outer surface of the capacitor body 110. The external electrodes 131 and 132 may include a first external electrode 131 and a second external electrode 132 disposed at opposite ends of the capacitor body 110 in the length direction (L-axis direction).

For example, the capacitor body 110 may have a roughly hexahedral shape.

For convenience of description of the present embodiments, the two surfaces opposing each other in the thickness direction (T-axis direction) of the capacitor body 110 are referred to as first and second surfaces, the two surfaces connected to the first and second surfaces and opposing each other in the length direction (L-axis direction) are referred to as third and the fourth surfaces, and two surfaces connected to the first and second surfaces and to the third and fourth surfaces, and opposing each other in the width direction (W-axis direction) are referred to as the fifth and sixth surfaces.

As an example, the first surface, which is the lower surface, may be a surface facing the mounting direction. Additionally, the first to the sixth surfaces may be flat, but the present embodiments are not limited thereto. For example, the first to the sixth surfaces may be curved surfaces with a convex central portion, and the edges, which are the boundaries of each surface, may be rounded.

The shape and size of the capacitor body 110 and the number of stacks of the dielectric layers 111 are not limited to those shown in the drawings of the embodiment.

The capacitor body 110 includes a plurality of dielectric layers 111 and internal electrode layers 121 and 122. Specifically, the capacitor body 110 includes the plurality of dielectric layers 111 and a first internal electrode layer 121 and a second internal electrode layer 122 alternately disposed in the thickness direction (T-axis direction) interposing the dielectric layer 111.

At this time, the boundaries between adjacent dielectric layers 111 of the capacitor body 110 may be integrated to the extent that it is difficult to check without using a scanning electron microscope (SEM).

The capacitor body 110 may include an active region and cover regions 112 and 113.

The active region is a region where the dielectric layer 111 and the internal electrode layers 121 and 122 are alternately stacked, which contributes to forming capacitance of the multilayer capacitor 100. Specifically, the active region may be a region where the first internal electrode layer 121 or the second internal electrode layer 122 stacked along the thickness direction (T-axis direction) overlap.

The cover regions 112 and 113 are thickness-direction marginal portions, and may be positioned on the first and second surfaces of the body and the top and the bottom of the active region in the thickness direction (T-axis direction), respectively. The cover regions 112 and 113 may be a single dielectric layer 111 or two or more dielectric layers 111 stacked on the upper and lower surfaces of the active region, respectively.

Additionally, the capacitor body 110 may further include side margin regions.

The side margin regions may be located on opposite side ends of the active region in the width direction (W-axis direction), that is, on the fifth surface and the sixth surface, respectively. The side margin regions may be formed according as, when a conductive paste layer for the internal electrode is applies on a surface of a dielectric green sheet, the dielectric green sheets, which are applied with the conductive paste layer only in a partial region of the surface of the dielectric green sheet and not applied with the conductive paste layer on both side surfaces of the surface of the dielectric green sheet, are stacked and then fired, but the forming method is not limited thereto.

The cover regions 112 and 113 and the side margin regions may serve to prevent damage to the first internal electrode layer 121 and the second internal electrode layer 122 due to physical or chemical stress.

### Dielectric Layer

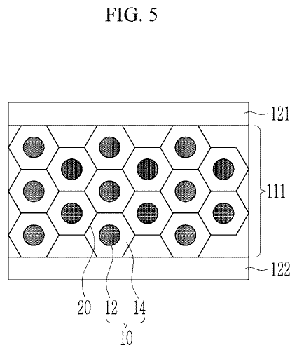

A dielectric layer 111 according to some embodiments will be described with reference to FIG. 5.

FIG. 5 is a schematic view showing the dielectric layer according to some embodiments of the present disclosure.

Referring to FIG. 5, a dielectric layer 111 includes a plurality of dielectric grains 10. Additionally, the dielectric layer 111 may further include a grain boundary 20 disposed between the plurality of dielectric grains 10.

At least one of the plurality of dielectric grains 10 may have a core-shell structure including a core portion 12 and a shell portion 14 surrounding at least a portion of the core portion 12.

The core portion 12 may include barium (Ba) and titanium (Ti), and the shell portion 14 may include calcium (Ca) and/or strontium (Sr), and zirconium (Zr).

Ba and Ti in the core portion 12 can be derived from a barium titanate-based compound used as a dielectric base material. The barium titanate-based compound can be a ferroelectric material with high dielectric constants and stable temperature characteristics. For example, the barium titanate-based compound may include one or more selected from the group consisting of BaTiO₃, Ba(Ti, Sn)O₃, (Ba, Ca)TiO₃, and (Ba, Sr)TiO₃.

Ca or Sr, and Zr in the shell portion 14 may be derived from a zirconium-based compound used as a dielectric base material. The zirconium-based compound can be a paraelectric material with high withstand voltage characteristics and excellent electric distortion characteristics. For example, the zirconium-based compound may include one or more selected from the group consisting of CaZrO₃, SrZrO₃, (Ba, Ca)ZrO₃, and (Ba, Sr)ZrO₃, for example, one or more selected from CaZrO₃ and SrZrO₃.

According to some embodiments, by mixing a base material of the barium titanate-based compound and a base material of the zirconium-based compound, it satisfies the temperature characteristics of the X7R grade in a medium dielectric constant range of 1500 to 2000 due to the material properties of the core portion 12, and can realize excellent reduction resistance, reliability, and withstand voltage characteristics due to the material properties of the shell portion 14.

In addition, Ca or Sr included in the shell portion 14 may prevent temperature characteristic deterioration by minimizing the low-temperature shift of the Curie temperature Tc of Zr.

The barium titanate-based compound, which is a ferroelectric material, has electric distortion and piezoelectric properties, and thus, when a high electric field is applied, stress and structural deformation may occur, which may cause physical and mechanical defects in the chip. Accordingly, high-voltage products are being developed through design methods that minimize high-voltage application, such as shield lamination and voltage division. However, these methods make it difficult to secure capacitance at the same dielectric constant, and in particular causes a decrease in direct current (DC) bias characteristics, which reduces product competitiveness. In addition, there is a strategy to secure capacitance and improve DC bias characteristics by minimizing design applications that lower the applied voltage, such as shield lamination and voltage division, through material design that increases the withstand voltage. However, these methods have the disadvantages of deteriorating temperature characteristics and low dielectric constant, which limits the development of models that simultaneously satisfy high capacitance and high voltage characteristics.

According to some embodiments, when the dielectric layer 111 has dielectric grains 10 including Ba and/or Ti derived from a ferroelectric material in the core portion 12, and Ca and/or Sr, and Zr derived from a paraelectric material in the shell portion 14, it may be possible to minimize temperature characteristic deterioration and, at the same time, minimize design applications that lower the boosting voltage through the shell portion 14 having a high withstand voltage. That is, since the temperature characteristics satisfy the X7R grade while simultaneously increasing the withstand voltage, design factors that impede the capacitance and DC bias characteristics, such as voltage division design, can be minimized. In addition, excellent reliability and reduction resistance may be realized through the shell portion 14 having a high withstand voltage, so that it can be used in high-voltage models that require a guaranteed voltage of 250 V or higher. In addition, technological competitiveness can be improved by minimizing temperature downgrade accompanying with improvement of withstand voltage characteristics. Accordingly, a multilayer ceramic capacitor having not only high capacitance and high voltage characteristics, but also excellent temperature characteristics, withstand voltage characteristics, and DC bias characteristics can be obtained.

In the dielectric grain 10 having the core-shell structure, in a TEM-EDS (transmission electron microscopy-energy dispersive spectroscopy) line analysis for a long-axis straight section passing through a center of the dielectric grain 10 having the core-shell structure, the core portion 12 may be a region in which zirconium (Zr) is less than about 3 parts by mole based on 100 parts by mole of titanium (Ti), and the shell portion 14 may be a region in which zirconium (Zr) is about 3 parts by mole or more based on 100 parts by mole of titanium (Ti). For example, the core portion 12 may be a region in which Zr is greater than about 0, 0.5, 1, 1.5, 2 or 2.5 parts by mole and less than about 3, 2.5, 2, 1.5, 1 or 0.5 parts by mole based on 100 parts by mole of Ti, and the shell portion 14 may be a region in which Zr is about 3, 4, 5, 6, 7, 8, 9, 10, 50, 100 or 200 parts by mole or more and less than about 300, 200, 100, 50, 10, 9, 8, 7, 6, 5 or 4 parts by mole based on 100 parts by mole of Ti.

The shell portion 14 may include Ca and/or Zr, or may include Sr and/or Zr.

The content of Ca and/or Sr in the shell portion 14 may be about 2.5 parts by mole to about 40 parts by mole based on 100 parts by mole of Ti, for example, about 2.8 parts by mole to about 35 parts by mole, or about 3.0 parts by mole to about 30 parts by mole based on 100 parts by mole of Ti. When the content of Ca and/or Sr in the shell portion 14 is within the above range, the design application for minimizing temperature characteristic deterioration and lowering the boosting voltage can be minimized. Accordingly, a multilayer ceramic capacitor having not only high capacitance and high voltage characteristics, but also excellent temperature characteristics, withstand voltage characteristics, and DC bias characteristics can be obtained.

Additionally, the content of Zr in the shell portion 14 may be about 3 parts by mole to about 150 parts by mole based on 100 parts by mole of Ti, for example, about 5 parts by mole to about 140 parts by mole, about 7 parts by mole to about 130 parts by mole, or about 10 parts by mole to about 120 parts by mole based on 100 parts by mole of Ti. When the content of Zr in the shell portion 14 is within the above range, the design application for minimizing the deterioration of temperature characteristics and lowering the boosting voltage can be minimized, thereby securing a multilayer ceramic capacitor having not only high capacitance and high voltage characteristics but also excellent temperature characteristics, withstand voltage characteristics, and DC bias characteristics.

According to some embodiments, the shell portion 14 may further include a rare-earth element.

The rare-earth element may include an element with a larger ionic radius than yttrium (Y). For example, the rare-earth element may include one or more selected from the group consisting of dysprosium (Dy), gadolinium (Gd), lanthanum (La), and cerium (Ce). The element with larger ionic radii than Y prefers substitution at the A site in dielectric base materials represented by the chemical formula ABO₃. In some embodiments, the dielectric grain or the shell portion may not include holmium (Ho).

The rare-earth element included in the shell portion 14 may be derived from a rare-earth element-containing compound used as an additive added to the dielectric base material when forming the dielectric layer.

When the shell portion 14 further includes a rare-earth element in addition to Ca or Sr, and Zr, the withstand voltage characteristic, i.e. reliability, can be improved by suppressing oxygen vacancies by inducing n-type semiconductor characteristics through A site substitution of the rare-earth element.

The total content of the rare-earth element in the shell portion 14 may be about 0.5 part by mole to about 10 parts by mole based on 100 parts by mole of Ti, for example, about 0.7 part by mole to about 9 parts by mole, or about 1 part by mole to about 7 parts by mole based on 100 parts by mole of Ti. When the total content of the rare-earth element in the shell portion 14 is within the above range, a multilayer ceramic capacitor having high capacitance and high voltage characteristics as well as excellent temperature characteristics, withstand voltage characteristics, and DC bias characteristics can be obtained. When the total content of the rare-earth element in the shell portion 14 is less than about 0.5 part by mole based on 100 parts by mole of Ti, the withstand voltage characteristics may deteriorate, making it difficult to apply for high voltage, and when it exceeds about 10 parts by mole, the temperature characteristics may deteriorate. According to some embodiments, the shell portion 14 may further include a transition metal.

For example, the transition metal may include one or more selected from the group consisting of manganese (Mn), vanadium (V), and chromium (Cr).

The transition metal included in the shell portion 14 may be derived from a transition metal-containing compound used as an additive added to the dielectric base material when forming the dielectric layer.

When the shell portion 14 further includes a transition metal in addition to Ca or Sr, and Zr, the multilayer ceramic capacitor can have excellent temperature characteristics, and high capacitance and high voltage characteristics.

For example, the shell portion 14 may include Ca and/or Sr, Zr, the rare-earth element, and the transition metal.

The grain boundary 20 disposed between the plurality of dielectric grains 10 may include silicon (Si).

Silicon (Si) can be derived from a silicon (Si)-containing compound used as an additive added to a dielectric base material.

When Si is included in the grain boundary 20, the reliability of the multilayer ceramic capacitor can be improved due to improvement of grain boundary resistance.

The content of Si in the grain boundary 20 may be about 2.5 parts by mole to about 20 parts by mole based on 100 parts by mole of Ti, for example, about 2.8 parts by mole to about 19 parts by mole, about 3.0 parts by mole to about 18 parts by mole, or about 3.5 parts by mole to about 17 parts by mole based on 100 parts by mole of Ti. When the content of Si in the grain boundary 20 is within the above range, the reliability of the multilayer ceramic capacitor can be improved.

The grain boundary 20 may be a region in which Si is about 2.5 parts by mole to about 20 parts by mole based on 100 parts by mole of Ti, when analyzing a TEM-EDS (transmission electron microscope-energy dispersive spectroscopy) line along a straight section of a long axis passing through the center of the dielectric grain 10 having the core-shell structure within the dielectric layer 111.

The grain boundary 20 may include a rare-earth element in addition to Si.

The rare-earth element included in the grain boundary 20 may be derived from a rare-earth element-containing compound used as an additive added to the dielectric base material when forming the dielectric layer. That is, it may be identical to the rare-earth element included in the shell portion 14.

Specifically, the rare-earth element may include an element having an ionic radius larger than yttrium (Y), such as one or more selected from the group consisting of Dy, Gd, La, and Ce.

When the rare-earth element is included in addition to Si in the grain boundary 20, the insulating effect can be further enhanced.

The total content of the rare-earth element in the grain boundary 20 may be about 3 parts by mole to about 30 parts by mole based on 100 parts by mole of Ti, for example, about 4 parts by mole to about 29 parts by mole, about 5 parts by mole to about 28 parts by mole, or about 6 parts by mole to about 27 parts by mole based on 100 parts by mole of Ti. When the total content of the rare-earth element in the grain boundary 20 is within the above range, the multilayer ceramic capacitor can have excellent temperature characteristics, and high capacitance and high voltage characteristics.

The structure, components, and composition of the aforementioned dielectric layer 111 can be confirmed through TEM-EDS (transmission electron microscope-energy dispersive spectroscopy). TEM-EDS can be measured by the following methods.

After placing the multilayer ceramic capacitor 100 in an epoxy mixing solution and curing it, the L-axis and T-axis direction surfaces (LT surfaces) of the capacitor body 110 are polished to ½ of a depth in the W-axis direction to obtain a cross-sectional sample so that the active region where the dielectric layer 111 and the internal electrode layers 121 and 122 intersect can be observed. Next, when the active region of the cross-sectional sample is divided into three parts, an upper region, a central region, and a lower region, a TEM (transmission electron microscope) is used to measure that at least one dielectric layer 111 and at least one internal electrode layer 121 or 122 are visible in each region. TEM can be measured under conditions of an acceleration voltage of 200 kV and a magnification of 50,000 using a Xe-FIB (focused ion beam).

Next, EDS (Energy Dispersive Spectroscopy) mapping analysis of the dielectric layer is performed on the TEM image of the measured cross-sectional sample. From the EDS mapping analysis, the structure and components of dielectric grains 10 having the core-shell structure and grain boundaries 20 can be confirmed. That is, it can be confirmed that Ba and Ti may exist in the core portion 12 of the dielectric grain 10, and Ca and/or Sr, and Zr may exist in the shell portion 14 of the dielectric grain 10. Additionally, it can be confirmed that Si may exists at grain boundary 20.

In addition, by performing EDS (energy dispersive spectroscopy) line analysis on the dielectric layer in the TEM image of the measured cross-sectional sample, the component contents within the dielectric grains 10 having the core-shell structure and grain boundaries 20 can be confirmed. That is, the content of Ca or Sr, Zr, etc. in the aforementioned shell portion 14 and the content of Si, etc. in the grain boundary 20 can be confirmed.

Specifically, in each TEM image of the upper region, the central region, and the lower region, at least one dielectric layer 111 is arbitrarily selected for each region, and then at least one dielectric grain 10 having the core-shell structure and at least one grain boundary 20 can be selected in the dielectric layer 111. EDS line analysis can be performed on a straight section of the long axis passing through the center of the selected dielectric grain having the core-shell structure. For example, by randomly selecting one dielectric layer for each region and selecting five dielectric grains having the core-shell structure and grain boundaries for each dielectric layer, EDS line analysis can be performed for each of a total of 15 dielectric grains and grain boundaries. That is, the content of Ca and/or Sr, Zr, etc. in the shell portion 14 and the content of Si, etc. in the grain boundary 20 may be the average value of the content obtained from EDS line analysis for a total of 15.

In addition, as described above, the core portion 12 and the shell portion 14 in the dielectric grain 10 can be distinguished through the EDS line analysis. For example, the core portion 12 may be a region where Zr is less than about 3 parts by mole based on 100 parts by mole of Ti, and the shell portion 14 may be a region where Zr is about 3 parts by mole or more based on 100 parts by mole of Ti.

According to some embodiments, a diameter of the core portion 12 may be about 15% to about 85% of the diameter of the dielectric grain 10, for example about 18% to about 82%, about 20% to about 80%, about 23% to about 77%, or about 25% to about 75%. When the diameter of the core portion is within the above range, the multilayer ceramic capacitor can have not only excellent temperature characteristics but also high capacitance and high voltage characteristics.

The ratio of diameter of the core portion 12 can be measured by the following method.

In each TEM image of the upper region, central region, and lower region, at least one dielectric layer 111 is randomly selected for each region, and then at least one dielectric grain 10 having the core-shell structure is confirmed in the dielectric layer 111, and then the diameter of the dielectric grain 10 and the diameter of the core portion 12 are measured to obtain the ratio. For example, by randomly selecting one dielectric layer for each region and selecting five dielectric grains having the core-shell structure for each dielectric layer, the average value of diameter ratio of the core portion for a total of 15 dielectric grains can be calculated. At this time, the diameter of the dielectric grain 10 can be obtained as the average value of the major axis length having the maximum diameter and the minor axis length having the minimum diameter passing through the center of the dielectric grain 10. In addition, the diameter of the core portion 12 can be obtained as an average value of the length of the core portion 12 obtained on the major axis length having the maximum diameter and the length of the core portion 12 obtained on the minor axis length having the minimum diameter passing through the center of the dielectric grain 10.

The number of dielectric grains 10 having the core-shell structure may be about 5% to about 100% of the total number of dielectric grains present in the dielectric layer 111, for example, about 10% to about 95%, about 15% to about 90%, or about 20% to about 85%. When the number of dielectric grains 10 having the core-shell structure is within the above range, the multilayer ceramic capacitor can have not only excellent temperature characteristics but also high capacitance and high voltage characteristics. The number ratio of dielectric grains 10 having the core-shell structure can be measured by the following method.

In each TEM image of the upper region, central region, and lower region, at least one dielectric layer 111 is randomly selected for each region, and the total number of dielectric grains present in the dielectric layer and the number of dielectric grains 10 having the core-shell structure are measured to obtain the ratio of the number of dielectric grains having the core-shell structure. For example, by randomly selecting two dielectric layers for each region, the average value of the number ratios for a total of six dielectric layers can be calculated.

An average thickness (average length in the T-axis direction) of the dielectric layer 111 may be about 0.1 μm to about 8 μm, and for example, may be about 0.1 μm to about 6.0 μm. When the average thickness of the dielectric layer 111 is within the above range, the reliability of the multilayer ceramic capacitor may be improved.

The average thickness of the dielectric layer 111 can be measured by placing the multilayer ceramic capacitor 100 in an epoxy mixing solution, curing it, polishing it, and then ion milling it, and then analyzing it using a scanning electron microscope (SEM). The SEM can be measured under conditions of, for example, 10 kV and a magnification of 100 times, and can be measured so that at least 1 layer, 3 layers, 5 layers, or 10 layers of dielectric layers 111 are visible in the active region where the dielectric layer 111 and the internal electrode layers 121 and 122 intersect. In the SEM image, the average thickness of the dielectric layer can be obtained by taking the central point of the length direction (L-axis direction) or width direction (W-axis direction) of the dielectric layer 111 as a reference point in the scanning electron microscope (SEM) image, and taking the mean value of the thickness of the dielectric layer 111 at 10 points spaced apart from the reference point at a predetermined interval. The intervals of the 10 points may be adjusted depending on the scale of the SEM image, and may be, for example, about 1 μm to about 100 μm, about 1 μm to about 50 μm, or about 1 μm to about 10 μm. At this time, all 10 points must be positioned within the dielectric layer 111, and if all 10 points are not positioned within the dielectric layer 111, the position of the reference point may be changed, or the interval between the 10 points may be adjusted. In addition, by extending this average value measurement to 10 dielectric layers and measuring the average value, the average thickness of the dielectric layer can be more generalized.

### Internal Electrode Layer

The internal electrode layers 121 and 122, i.e., the first internal electrode layer 121 and the second internal electrode layer 122, are electrodes having different polarities and are alternately disposed to face each other along the T-axis direction with the dielectric layer 111 interposed between them, and one end may be exposed through the third and fourth surfaces of the capacitor body 110, respectively.

The first internal electrode layer 121 and the second internal electrode layer 122 may be electrically insulated from each other by the dielectric layer 111 disposed in the middle.

The ends of the first internal electrode layer 121 and the second internal electrode layer 122, which are alternately exposed through the third and fourth surfaces of the capacitor body 110, may be electrically connected to the first external electrode 131 and the second external electrode 132, respectively.

The internal electrode layers 121 and 122 include a conductive metal, and may include at least one selected from the group consisting of metals such as Ni, Cu, Ag, Pd, Au, and alloys thereof.

Additionally, the internal electrode layers 121 and 122 may include dielectric particles having the same composition as the ceramic material included in the dielectric layer 111.

The internal electrode layers 121 and 122 can be formed using a conductive paste including the conductive metal. The printing method for the conductive paste can be either screen printing or gravure printing.

Each average thickness of the first internal electrode layer 121 and the second internal electrode layer 122 may be about 0.1 μm to about 2 μm.

The average thickness of the first internal electrode layer 121 and the second internal electrode layer 122 may be measured by a scanning electron microscope (SEM) analysis. Specifically, in the SEM image of the cross-sectional sample obtained by the same method as the method for measuring the average thickness of the dielectric layer 111, the average thickness of the internal electrode layers can be obtained by taking the central point of the length direction (L-axis direction) or width direction (W-axis direction) of each of the internal electrode layers 121 and 122 as a reference point, and taking the mean value of the thickness of each of the internal electrode layers 121 and 122 at 10 points spaced apart from the reference point at a predetermined interval. The intervals of the 10 points may be adjusted depending on the scale of the SEM image, and may be, for example, about 1 μm to about 100 μm, about 1 μm to about 50 μm, or about 1 μm to about 10 μm. At this time, all 10 points must be positioned within each of the internal electrode layers 121 and 122, and if all 10 points are not positioned within each of the internal electrode layers 121 and 122, the position of the reference point may be changed, or the interval between the 10 points may be adjusted. In addition, by extending this average value measurement to 10 internal electrode layers and measuring the average value, the average thickness of the internal electrode layers can be more generalized.

The capacitor body 110 may be formed by firing a stacking structure in which the plurality of dielectric layers 111 and internal electrode layers 121 and 122 are stacked.

### External Electrode

The external electrodes 131 and 132, i.e., the first external electrode 131 and the second external electrode 132 are provided with voltages of different polarities and may be electrically connected with exposed portions of the first internal electrode layer 121 and the second internal electrode layer 122, respectively.

According to the above configuration, when a predetermined voltage is applied to the first external electrode 131 and the second external electrode 132, charges are accumulated between the first internal electrode layer 121 and the second internal electrode layer 122 facing each other. At this time, the capacitance of the multilayer capacitor 100 is proportional to the overlapping area of the first internal electrode layer 121 and the second internal electrode layer 122 that overlap each other along the T-axis direction in the active region.

The first external electrode 131 and the second external electrode 132 may include, respectively, first and second connection portions disposed on the third and fourth surfaces of the capacitor body 110 and connected to the first internal electrode layer 121 and the second internal electrode layer 122, and first and second band portions disposed on edges where the third and fourth surfaces of the capacitor body 110 meet the first and second surfaces or the fifth and sixth surfaces.

The first and second band portions may extend, respectively, from the first and second connection portions to portions of the first and second surfaces or the fifth and sixth surfaces of the capacitor body 110. The first and second band portions may serve to improve the adhesion strength of the first external electrode 131 and the second external electrode 132.

The external electrodes 131 and 132 may include a sintered metal layer in contact with the capacitor body 110, a conductive resin layer disposed to cover the sintered metal layer, and a plating layer disposed to cover the conductive resin layer.

The sintered metal layer may include a conductive metal and glass.

The conductive metal may include one or more selected from copper (Cu), nickel (Ni), silver (Ag), palladium (Pd), gold (Au), platinum (Pt), tin (Sn), tungsten (W), titanium (Ti), lead (Pb), and an alloy thereof, and for example, the term copper (Cu) may include a copper (Cu) alloy. When the conductive metal includes copper (Cu), metals other than copper (Cu) may be included in an amount of less than or equal to about 5 parts by mole based on 100 parts by mole of copper (Cu).

The glass may include a composition of mixed oxides, for example, one or more selected from the group consisting of silicon oxide, boron oxide, aluminum oxide, transition metal oxide, alkali metal oxide, and alkaline earth metal oxide. The transition metal may include at least one selected from the group consisting of zinc (Zn), titanium (Ti), copper (Cu), vanadium (V), manganese (Mn), iron (Fe) and nickel (Ni), the alkali metal may be selected from a group consisting of lithium (Li), sodium (Na) and potassium (K), and the alkaline-earth metal may include at least one selected from the group consisting of magnesium (Mg), calcium (Ca), strontium (Sr) and barium (Ba).

Optionally, the conductive resin layer may be formed on the sintered metal layer, and for example, may be formed in the shape that completely covers the sintered metal layer. Meanwhile, the external electrodes 131 and 132 may not include the sintered metal layer, and in this case, the conductive resin layer may directly contact the capacitor body 110.

The conductive resin layer extends to the first and second surfaces or the fifth and sixth surfaces of the capacitor body 110, and the length of the region (i.e., band portion) where the conductive resin layer is extended and disposed to the first and second surfaces or the fifth and sixth surfaces of the capacitor body 110 may be longer than the length of the region (i.e., band portion) where the sintered metal layer is extended and disposed to the first and second surfaces or the fifth and sixth surfaces of the capacitor body 110. That is, the conductive resin layer may be formed on the sintered metal layer, and may be formed in the shape that completely covers the sintered metal layer.

The conductive resin layer may include a resin and a conductive metal.

The resin included in the conductive resin layer may be implemented by a material which has adhesive properties and shock absorption properties and is able to form a paste when mixed with the conductive metal powder, but is not limited thereto. For example, the resin may include a phenolic resin, an acrylic resin, a silicone resin, an epoxy resin, or a polyimide resin.

The conductive metal included in the conductive resin layer serves to be electrically connected to the internal electrode layers 121 and 122 or the sintered metal layer.

The conductive metal included in the conductive resin layer may have a spherical shape, a flake shape, or a combination thereof. That is, the conductive metal may be formed only in flake form, only in spherical form, or in a mixed form of flake form and spherical form.

Here, the spherical shape may also include a shape that is not a perfect spherical shape, for example, a shape in which the length ratio of the major axis and the minor axis (major axis/minor axis) is less than or equal to about 1.45. Flake shape powder refers to a powder with a flat and elongated shape, and is not particularly limited. But for example, the length ratio of the major axis and the minor axis (major axis/minor axis) may be greater than or equal to about 1.95.

The external electrodes 131 and 132 may further include the plating layer disposed outside the conductive resin layer.

The plating layer may include at least one selected from the group consisting of nickel (Ni), copper (Cu), tin (Sn), palladium (Pd), platinum (Pt), gold (Au), silver (Ag), tungsten (W), titanium (Ti), lead (Pb), and alloys thereof. For example, the plating layer may be a Ni plating layer or a Sn plating layer, and may be in a form in which a Ni plating layer and a Sn plating layer are sequentially laminated, or may be in a form in which a Sn plating layer, a Ni plating layer, and a Sn plating layer are sequentially laminated. Additionally, the plating layer may include a plurality of Ni plating layers and/or a plurality of Sn plating layers.

The plating layer may improve mountability to the substrate, structural reliability, durability to the outside, heat resistance, and equivalent series resistance (ESR) of the multilayer ceramic capacitor 100.

### Method of Manufacturing Multilayer Ceramic Capacitor

Hereinafter, a method of manufacturing the multilayer ceramic capacitor 100 according to some embodiments will be described.

A multilayer ceramic capacitor 100 according to an embodiment may be manufactured by preparing a dielectric slurry comprising main component powders including a barium titanate-based compound and a zirconium-based compound; manufacturing a dielectric green sheet from the dielectric slurry, and forming a conductive paste layer on a surface of the dielectric green sheet; manufacturing a dielectric green sheet stack by stacking a plurality of the dielectric green sheets on which the conductive paste layer is formed; manufacturing a capacitor body including a dielectric layer and an internal electrode layer by firing the dielectric green sheet stack; and forming an external electrode on an outer surface of the capacitor body.

The barium titanate-based compound may include at least one selected from the group consisting of BaTiO₃, Ba(Ti, Sn)O₃, (Ba, Ca)TiO₃, and (Ba, Sr)TiO₃.

The zirconium-based compound may include at least one selected from the group consisting of a compound containing Zr and Ca and a compound containing Zr and Sr

For example, the zirconium-based compound may include one or more selected from the group consisting of CaZrO₃, SrZrO₃, (Ba, Ca)ZrO₃, and (Ba, Sr)ZrO₃. For example, the zirconium-based compound may include one or more selected from the group consisting of CaZrO₃ and SrZrO₃.

The barium titanate-based compound and the zirconium-based compound can be used in a mixed or coated form. That is, the main component powders comprise a mixture of the barium titanate-based compound and the zirconium-based compound, or a composite in which the zirconium-based compound is coated on a surface of the barium titanate-based compound.

The composite may be, for example, a composite formed with a structure of a core of a barium titanate-based compound, which is a ferroelectric, and a shell coated on the surface of the core with a zirconium-based compound, which is a paraelectric.

The zirconium-based compound may be included in an amount of about 1 mol % to about 20 mol % based on a total amount of the barium titanate-based compound and the zirconium-based compound, for example, about 2 mol % to about 19 mol %, about 3 mol % to about 18 mol %, or about 4 mol % to about 17 mol %. When the zirconium-based compound is included in the above content range, the multilayer ceramic capacitor can have excellent temperature characteristics and high capacitance and high voltage characteristics.

The dielectric slurry may further include a secondary component powder.

The secondary component powder may include at least one selected from the group consisting of a silicon (Si)-containing compound, a rare-earth element-containing compound, and a transition metal-containing compound.

For example, the rare-earth element-containing compound may include at least one selected from the group consisting of a dysprosium (Dy)-containing compound, a gadolinium (Gd)-containing compound, a lanthanum (La)-containing compound, and a cerium (Ce)-containing compound.

The rare-earth element-containing compound may be included in an amount of about 0.5 part by mole to about 10 parts by mole based on 100 parts by mole of the main component powders.

For example, the transition metal-containing compound may include at least one selected from the group consisting of a manganese (Mn)-containing compound, a vanadium (V)-containing compound, and a chromium (Cr)-containing compound.

For example, the secondary component powder may include a silicon (Si)-containing compound, a rare-earth element-containing compound, or a transition metal-containing compound.

The dielectric slurry may be prepared by additionally mixing additives such as a dispersant, a binder, a plasticizer, a lubricant, an antistatic agent, and a solvent.

The dispersant may include, for example, at least one selected from the group consisting of a phosphoric acid ester-based dispersant and a polycarboxylic acid-based dispersant. The dispersant may be mixed in an amount of about 0.1 part by weight to about 5 parts by weight, for example, about 0.3 part by weight to about 3 parts by weight based on 100 parts by weight of the barium titanate-based compound. When the dispersant is mixed within the above content range, the dielectric slurry shows excellent dispersibility, and the amount of impurities included in the manufactured dielectric layer may be reduce.

The binder may be, for example, an acrylic resin, a polyvinyl butyl resin, a polyvinyl acetal resin, an ethylcellulose resin, or the like. The binder may be added in an amount of about 0.1 part by weight to about 50 parts by weight, for example, about 3 parts by weight to about 30 parts by weight, based on 100 parts by weight of the barium titanate-based compound. When the binder is mixed within the above content range, the dielectric slurry shows excellent dispersibility, and the amount of impurities included in the manufactured dielectric layer may be reduced.

The plasticizer may be, for example, a phthalic acid-based compound such as dioctyl phthalate, benzyl butyl phthalate, dibutyl phthalate, dihexyl phthalate, di(2-ethylhexyl) phthalate, and di(2-ethylbutyl) phthalate; an adipic acid-based compound such as dihexyl adipate and di(2-ethylhexyl) adipate; a glycol-based compound such as ethylene glycol, diethylene glycol, and triethylene glycol; a glycol ester-based compound such as triethylene glycol dibutyrate, triethylene glycol di(2-ethylbutyrate), and triethylene glycol di(2-ethylhexanoate); and the like. The plasticizer may be added in an amount of about 0.1 part by weight to about 20 parts by weight, for example, about 1 part by weight to about 10 parts by weight, based on 100 parts by weight of the barium titanate-based compound. When the plasticizer is mixed within the above content range, the dielectric slurry shows excellent dispersibility, and the amount of impurities included in the manufactured dielectric layer may be reduced.

The solvent may be an aqueous solvent such as water; an alcohol-based solvent such as ethanol, methanol, benzyl alcohol, and methoxyethanol; a glycol-based solvent such as ethylene glycol and diethylene glycol; a ketone-based solvent such as acetone, methyl ethyl ketone, methyl isobutyl ketone, and cyclohexanone; an ester-based solvent such as butyl acetate, ethyl acetate, carbitol acetate, and butylcarbitol acetate; an ether-based solvent such as methyl cellosolve, ethyl cellosolve, butyl ether, and tetrahydrofuran; an aromatic-based solvent such as benzene, toluene, and xylene, or the like. The solvent may be, for example, an alcohol-based solvent or aromatic-based solvent, considering solubility or dispersibility of various additives included in the dielectric slurry. The solvent may be mixed in an amount of about 50 parts by weight to about 1000 parts by weight, and for example, about 100 parts by weight to about 500 parts by weight based on 100 parts by weight of the barium titanate-based compound. When the solvent is mixed within the above content range, the dielectric slurry components may be sufficiently mixed, and subsequent removal of the solvent is easy.

The dielectric slurry described above may be mixed by using a wet ball mill or a stirred mill. When using the zirconia balls in the wet ball mill, a plurality of zirconia balls with a diameter of about 0.1 mm to about 10 mm may be used for wet mixing for about 8 hours to about 48 hours, or about 10 hours to about 24 hours.

The prepared dielectric slurry is formed into a dielectric layer after firing.

As a method of molding the prepared the dielectric slurry into a sheet shape, a tape molding method such as a doctor blade method, a calendar roll method, etc. may be used, for example, an on-roll molding coater with a head discharge method, and a dielectric green sheet may be obtained by drying the molded body afterward.

To form a conductive paste layer that becomes the internal electrode layer after firing, a conductive paste can be prepared by mixing a conductive powder made of a conductive metal or an alloy thereof, a binder, and a solvent. Additionally, barium titanate powder may be mixed in as a co-agent if necessary. The co-agent can act to inhibit the sintering of the conductive powder during the firing process. A conductive paste layer is formed by applying the conductive paste in a predetermined pattern on a surface of the dielectric green sheet using various printing methods such as screen printing or a transfer method.

The conductive powder may include nickel (Ni) or a nickel (Ni) alloy.

Next, a dielectric green sheet stack is prepared by stacking a plurality of layers of dielectric green sheets on which internal electrode patterns are formed, and then pressing the plurality of layers of dielectric green sheets in the stacking direction. At this time, the dielectric green sheet and the internal electrode pattern may be stacked so that the dielectric green sheet is positioned on the upper and lower surfaces of the dielectric green sheet stack in the stacking direction.

The cutting of the manufactured dielectric green sheet stack to a predetermined size by dicing or the like may optionally be performed.

Additionally, the dielectric green sheet stack may be solidified and dried to remove plasticizers, etc., if necessary, and after solidified and dried, the dielectric green sheet stack may be barrel polished using a horizontal centrifugal barrel machine, and the like. In barrel polishing, the dielectric green sheet stack is placed into a barrel container with media and polishing liquid, and rotational motion or vibration is applied to the barrel container, thus unnecessary parts, such as burrs generated during cutting, may be polished. Additionally, after barrel polishing, the dielectric green sheet stack may be washed with a cleaning solution such as water, and dried.

Subsequently, the capacitor body may be manufactured after binder removal treatment (calcinating) and firing of the dielectric green sheet stack.

The conditions for binder removal may be appropriately adjusted depending on the components of the dielectric layer or the internal electrode layer. For example, the rate of temperature rise during binder removal treatment may be about 5° C./hour to about 300° C./hour, the support temperature may be about 180° C. to about 400° C., and the temperature holding time may be about 0.5 hour to about 24 hours. The binder removal may be performed under an air atmosphere or a reducing atmosphere.

The conditions of the firing treatment can be appropriately adjusted depending on the main component composition of the dielectric layer or the main component composition of the internal electrode layer. For example, the firing can be performed at a temperature of about 1100° C. to about 1400° C., for example, at a temperature of about 1200° C. to about 1350° C. Additionally, the firing may be performed for about 0.5 hour to about 8 hours, for example, about 1 hour to about 3 hours. Additionally, the firing may be performed in a reducing atmosphere, for example, in a humidified mixed gas of nitrogen and hydrogen, and for example, may be performed under conditions such as a hydrogen concentration of 1.0% or less. When the internal electrode layer includes nickel (Ni) or a nickel (Ni) alloy, the oxygen partial pressure in the firing atmosphere may be about 1.0×10⁻¹⁴ MPa to about 1.0×10⁻¹⁰ MPa.

After firing, annealing may be performed as needed. The annealing is a treatment to re-oxidize the dielectric layer, and annealing may be performed if firing is performed in a reducing atmosphere. The conditions of the annealing treatment may also be appropriately adjusted depending on the components of the dielectric layer. For example, the annealing temperature may be about 950° C. to about 1150° C., the time may be about 0 to about 20 hours, and the rate of temperature rise may be about 50° C./hour to about 500° C./hour. The annealing atmosphere may be a humidified nitrogen gas (N₂) atmosphere, and an oxygen partial pressure may be about 1.0×10⁻⁹ MPa to about 1.0×10⁻⁵ MPa.

In binder removal treatment, firing treatment, or annealing treatment, for example, a wetter may be used to humidify nitrogen gas or mixed gas. In this case, the water temperature may be about 5° C. to about 75° C. The binder removal treatment, firing treatment, and annealing treatment may be performed sequentially or independently.

Optionally, surface treatment such as sand blasting, laser irradiation, barrel polishing, etc. may be performed on the third and fourth surfaces of the prepare capacitor body 110. By performing this surface treatment, the ends of the first internal electrode layer and the second internal electrode layer may be exposed to the outermost surfaces of the third and fourth surfaces, and thus the electrical connection between the first external electrode layer and the second external electrode layer, and the first internal electrode and the second internal electrode may be improved, alloy portions may be easily formed.

Subsequently, the external electrode is formed on a surface of the manufactured capacitor body 110.

According to some embodiments, a paste for forming the sintered metal layer may be applied to the external electrode and then sintered to form the sintered metal layer.

The paste for forming the sintered metal layer may include a conductive metal and glass. Since the description of the conductive metal and glass is the same as described above, repetitive description will be omitted. Additionally, the paste for forming the sintered metal layer may optionally include a binder, solvent, dispersant, plasticizer, oxide powder, and the like. The binder may be, for example, ethylcellulose, acrylic, butyral, etc., and the solvent may be, for example, an organic solvent or aqueous solvent such as terpineol, butylcarbitol, alcohol, methyl ethyl ketone, acetone, toluene, and the like.

Methods for applying the paste for forming the sintered metal layer on the outer surface of the capacitor body 110 may include various printing methods such as dip method and screen printing, application method using a dispenser, etc., and spraying method using spray. The paste for forming the sintered metal layer may be applied to at least the third and fourth surfaces of the capacitor body 110, and optionally applied to a part of the first, second, fifth, or the sixth surfaces on which the band portions of the first and second external electrodes are formed.

Thereafter, the capacitor body 110 applied with the paste for forming the sintered metal layer is dried, and sintered at a temperature of about 700° C. to about 1000° C. for about 0.1 hour to about 3 hours, to form the sintered metal layer.

Optionally, a paste for forming the conductive resin layer is applied on an outer surface of the obtained capacitor body 110 and then cured, to form the conductive resin layer.

The paste for forming the conductive resin layer may include a resin and, optionally, a conductive metal or a non-conductive filler. Since the description of the conductive metal and resin is the same as described above, repetitive description will be omitted. Additionally, the paste for forming the conductive resin layer may optionally include a binder, a solvent, a dispersant, a plasticizer, an oxide powder, and the like. The binder may include, for example, ethylcellulose, acrylic, butyral, etc., and the solvent may include an organic solvent or aqueous solvent such as terpineol, butylcarbitol, alcohol, methyl ethyl ketone, acetone, and toluene.

For example, the conductive resin layer may be formed by dipping the capacitor body 110 in the paste for forming the conductive resin layer and then curing it, or by printing the paste for forming the conductive resin layer on the surface of the capacitor body 110 by a screen-printing method or a gravure printing method, or by applying the paste for forming the conductive resin layer to the surface of the capacitor body 110 and then curing it.

Next, a plating layer is formed on the outside of the conductive resin layer.

For example, the plating layer may be formed by a plating method, sputtering, or electrolytic plating (electric deposition).

Hereinafter, the embodiments are illustrated in more detail with reference to examples. However, these examples are exemplary, and the scope of claims is not limited thereto.

### (Manufacturing of Multilayer Ceramic Capacitors)

### Examples 1 to 5

A dielectric slurry was prepared by mixing main component powders including barium titanate (BaTiO₃) and calcium zirconate (CaZrO₃) in a molar ratio of 9:1, and a secondary component powder. Here, the secondary component powder is a mixture of rare-earth element oxides including dysprosium oxide (Dy₂O₃) and gadolinium oxide (Gd₂O₃), silicon dioxide (SiO₂), and transition metal oxides including manganese dioxide (MnO₂), vanadium oxide (V₂O₅), and chromium oxide (Cr₂O₃). At this time, the rare-earth element oxides were mixed in an amount of 0.1 part by mole (Example 1), 0.5 part by mole (Example 2), 5.0 parts by mole (Example 3), 10.0 parts by mole (Example 4), and 13.0 parts by mole (Example 5), respectively, based on 100 parts by mole of the main component powder. SiO₂ was mixed in an amount of 2 parts by mole based on 100 parts by mole of the main component powder. The transition metal oxides were mixed in an amount of 0.4 part by mole based on 100 parts by mole of the main component powder.

In addition, the dielectric slurry was prepared by mechanical milling after adding ethanol/toluene, a wetting dispersant, and polyvinyl butyral (PVB) as a binder together using zirconia balls (ZrO₂ balls) as a dispersion medium.

The prepared dielectric slurry was used by using a head discharge type on-roll forming coater to manufacture a dielectric green sheet.

A conductive paste layer including nickel (Ni) was printed on a surface of the dielectric green sheet, and the dielectric green sheets on which the conductive paste layers were formed were stacked and pressed to manufacture a dielectric green sheet stack.

The dielectric green sheet stack was calcined at a temperature of 400° C. or less in a nitrogen atmosphere, and then fired under conditions of a firing temperature of 1300° C. or less and a hydrogen concentration of 1.0% H₂ or less.

Next, a multilayer ceramic capacitor was manufactured through processes such as forming of external electrodes and plating.

### Comparative Example 1

A multilayer ceramic capacitor was manufactured in the same manner as in Example 3, except that BaTiO₃ alone was used as the main component powder.

### Evaluation 1: TEM-EDS Analysis

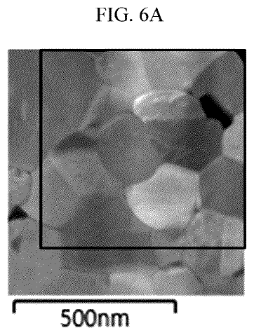

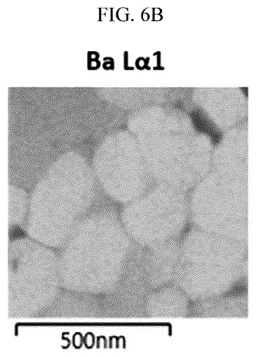

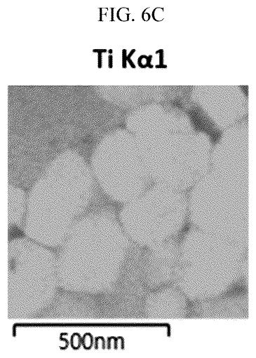

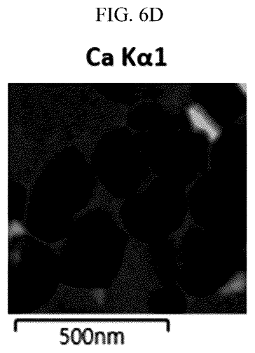

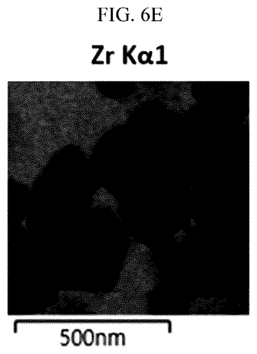

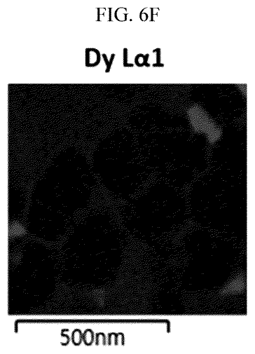

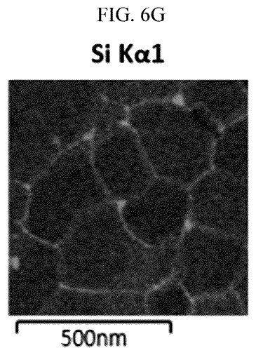

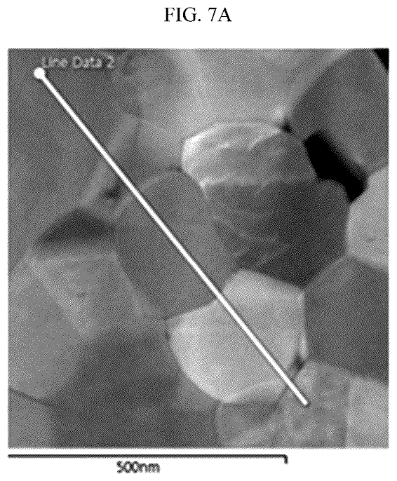

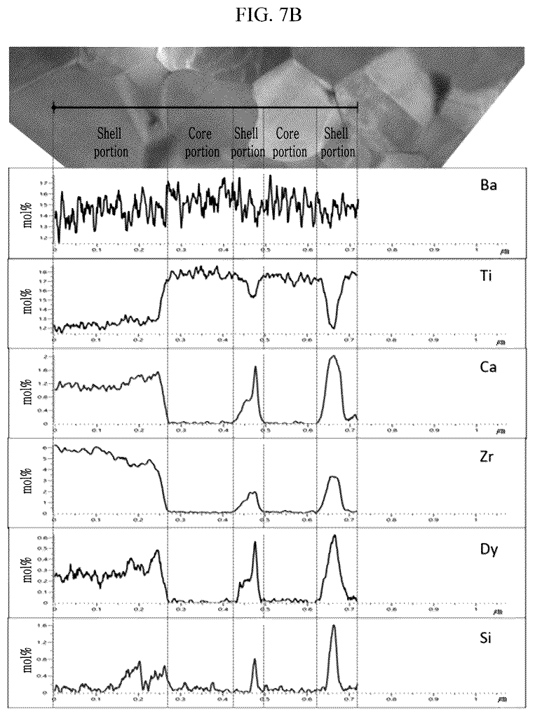

TEM-EDS (transmission electron microscope-energy dispersive spectroscopy) analysis was performed on the multilayer ceramic capacitors manufactured in Examples 1 to 5 and Comparative Example 1 by the following method, and the results are shown in FIGS. 6A to 6G and FIGS. 7A and 7B, and Table 1 below.

Each multilayer ceramic capacitor was placed in an epoxy mixing solution and cured, and then the L-axis and T-axis direction surface (LT surface) of the capacitor body was polished to ½ depth in the W-axis direction to obtain a cross-sectional sample so that the active region where the dielectric layer and the internal electrode layer intersect can be observed. Next, when the active region of the cross-sectional sample was divided into three parts, an upper region, a central region, and a lower region, a cross-sectional sample was obtained so that at least one dielectric layer and at least one internal electrode layer were visible in each region, and the cross-sectional sample was measured using a transmission electron microscope (TEM). TEM was measured using a Xe-FIB (focused ion beam) at an acceleration voltage of 200 kV and a magnification of 50,000×. Next, EDS (Energy Dispersive Spectroscopy) mapping analysis was performed on the dielectric layer from the TEM images of the measured cross-sectional samples.

FIG. 6A to FIG. 6G are TEM-EDS (transmission electron microscopy-energy dispersive spectroscopy) mapping analysis images for the dielectric layer according to Example 3.

Referring to FIGS. 6A to 6G and Table 1 below, it can be confirmed that the dielectric layer according to Example 3 includes dielectric grains having a core-shell structure and grain boundaries. Additionally, it can be confirmed that Ba and Ti exist in the core portion of the dielectric grain, and Ca and Zr exist in the shell portion of the dielectric grain. Additionally, it can be confirmed that Si exists at the grain boundary.

In addition, in each TEM image of the measured upper region, central region, and lower region, one dielectric layer was randomly selected for each region, and five dielectric grains having the core-shell structure and grain boundaries were selected for each dielectric layer, and EDS line analysis was performed for each of a total of 15 dielectric grains and grain boundaries. EDS line analysis was performed on the long-axis straight section passing through the center of the dielectric grain having the core-shell structure.

FIG. 7A and FIG. 7B are TEM-EDS (transmission electron microscopy-energy dispersive spectroscopy) line analysis images for the dielectric layer according to Example 3.

Referring to FIGS. 7A and 7B, in the case of Example 3, the core portion within the dielectric grain may be a region in which Zr is less than 3 parts by mole based on 100 parts by mole of Ti, and the shell portion may be a region in which Zr is 3 parts by mole or more based on 100 parts by mole of Ti.

In addition, the total content of rare-earth elements present in the shell portion of the dielectric grain was measured from the TEM-EDS line analysis, and is shown in Table 1 below. In Table 1 below, the total content of rare-earth elements was obtained as an average value of the contents obtained from EDS line analysis for the above 15 dielectric grains, and the total content of rare-earth elements was expressed based on 100 parts by mole of Ti.

TABLE 1

| | | A total content of rare-earth |
|---|---|---|
| | main component | elements within shell |
| | powders | portion (parts by mole) |
| Example 1 | BaTiO₃ + CaZrO₃ | 0.1 |
| Example 2 | BaTiO₃ + CaZrO₃ | 0.5 |
| Example 3 | BaTiO₃ + CaZrO₃ | 5.0 |
| Example 4 | BaTiO₃ + CaZrO₃ | 10.0 |
| Example 5 | BaTiO₃ + CaZrO₃ | 13.0 |
| Comparative | BaTiO₃ | 5.0 |
| Example 1 | | |

From the above TEM-EDS analysis, it can be seen that in the case of Examples 1 to 5, Ba and Ti are present in the core portion of the dielectric grain, and Ca and Zr are present in the shell portion of the dielectric grain, whereas in the case of Comparative Example 1, Ca and Zr are not present in the dielectric grain.

### Evaluation 2: Temperature Characteristic (TCC)

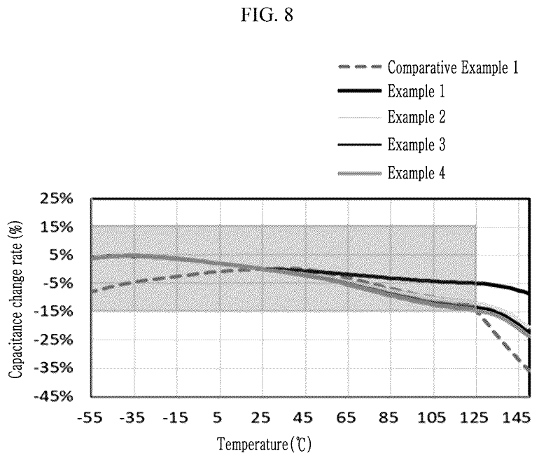

The temperature coefficient of capacitance (TCC) of the multilayer ceramic capacitors manufactured in Examples 1 to 4 and Comparative Example 1 was measured by the following method, and the results are shown in FIG. 8.

Capacitance was measured at 2° C. intervals in a temperature range of −55° C. to 150° C. under application conditions of 1 kHz and AC 1V. From the measurement of the capacitance, the change rate of capacitance at each temperature with respect to the capacitance at 25° C. was calculated according to the following Equation 1.

$$Capacitance change rate ( \% ) = [ ( C - CRT ) / CRT ] \times 100 \qquad [ Equation 1 ]$$

(In Equation 1, C is the capacitance measured within a temperature range of −55° C. to 150° C., and CRT is the capacitance measured at 25° C.)

FIG. 8 is a graph showing a temperature coefficient of capacitance (TCC) of the multilayer ceramic capacitors according to Examples 1 to 4 and Comparative Example 1.

Referring to FIG. 8, in the case of Examples 1 to 4 in which Ba and Ti are included in the core portion and Ca and Zr are included in the shell portion, it can be seen that the capacitance change is small between −55° C. and 125° C., so that the temperature characteristics satisfy the X7R grade, i.e., the temperature characteristics are excellent.

### Evaluation 3: STEP-IR Measurement

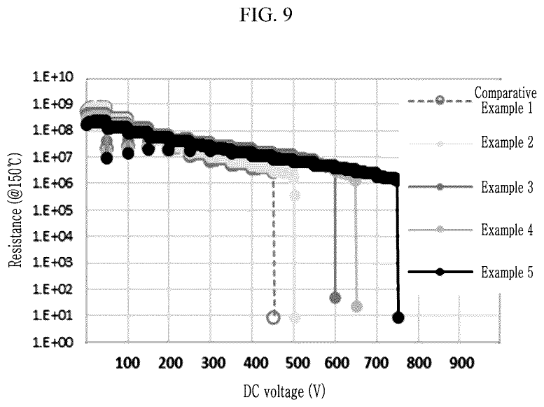

STEP-IR, i.e., resistance deterioration behavior according to voltage step increase, was evaluated for the multilayer ceramic capacitors manufactured in Examples 2 to 5 and Comparative Example 1 using the following method, and the results are shown in FIG. 9.

STEP-IR measurement was preformed by measuring the resistance degradation behavior by increasing the voltage step by 50 V at 150° C., with each step lasting 5 minutes and the resistance value measured at 10 second intervals.

Additionally, the withstand voltage characteristics were evaluated from STEP-IR measurements. This means the voltage at which IR withstands 105 (2 or more, when measuring by applying a voltage step of DC 50V for 5 minutes at 150° C. and continuously increasing this voltage step.

FIG. 9 is a graph showing STEP-IR characteristics of the multilayer ceramic capacitors according to Examples 2 to 5 and Comparative Example 1.

Referring to FIG. 9, it can be seen that Examples 2 to 5, in which Ba and Ti are included in the core portion and Ca and Zr are included in the shell portion, exhibit superior withstand voltage characteristics compared to Comparative Example 1.

### Evaluation 4: DC Bias Characteristic

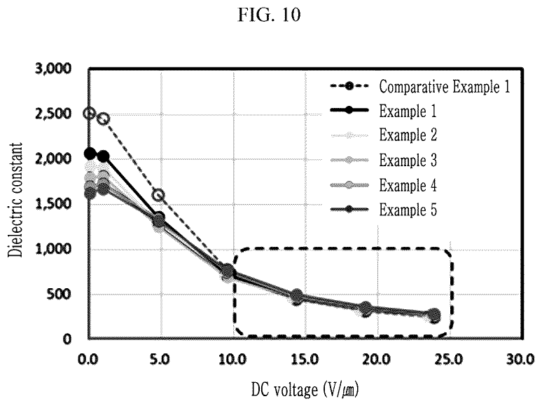

DC bias characteristics of the multilayer ceramic capacitors manufactured in Examples 1 to 5 and Comparative Example 1 were evaluated by the following method, and the results are shown in FIG. 10.

Under conditions of 1 kHz and AC 1V, DC 0 V/μm, 1.0 V/μm, 4.8 V/μm, 9.6 V/μm, 14.3 V/μm, 19.1 V/μm, and 23.9 V/μm were maintained for 60 seconds, respectively, and then each dielectric constant was measured.

FIG. 10 is a graph showing DC bias characteristics of the multilayer ceramic capacitors according to Examples 1 to 5 and Comparative Example 1.

Referring to FIG. 10, it can be seen that the DC bias characteristics of Examples 1 to 5, in which Ba and Ti are included in the core portion and Ca and Zr are included in the shell portion, are superior to those of Comparative Example 1.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

10: dielectric grain
12: core portion
14: shell portion
20: grain boundary
100: multilayer ceramic capacitor
110: capacitor body
111: dielectric layer
121: first internal electrode layer
122: second internal electrode layer
131: first external electrode
132: second external electrode

What is claimed is:

1. A multilayer ceramic capacitor, comprising
a capacitor body including a dielectric layer and an internal electrode layer, and
wherein the dielectric layer comprises a plurality of dielectric grains,
at least one of the plurality of dielectric grains has a core-shell structure including a core portion and a shell portion surrounding at least a part of the core portion,
the core portion comprises barium (Ba) and titanium (Ti),
the shell portion comprises calcium (Ca) or strontium (Sr), and zirconium (Zr), and
in a TEM-EDS (transmission electron microscopy-energy dispersive spectroscopy) line analysis for a long-axis straight section passing through a center of the at least one of the plurality of dielectric grains having the core-shell structure, the core portion includes less than 3 parts by mole of zirconium (Zr) based on 100 parts by mole of titanium (Ti) of the dielectric grains, and the shell portion includes 3 parts by mole or more of zirconium (Zr) based on 100 parts by mole of titanium (Ti) of the dielectric grains.

2. The multilayer ceramic capacitor of claim 1, wherein
the shell portion comprises based on 100 parts by mole of titanium (Ti) of the dielectric grains: 2.5 parts by mole to 40 parts by mole of calcium (Ca); 2.5 parts by mole to 40 parts by mole of strontium (Sr); or 2.5 parts by mole to 40 parts by mole of a total of calcium (Ca) and strontium (Sr).

3. The multilayer ceramic capacitor of claim 1, wherein
the shell portion comprises zirconium (Zr) in an amount of 3 parts by mole to 150 parts by mole based on 100 parts by mole of titanium (Ti) of the dielectric grains.

4. The multilayer ceramic capacitor of claim 1, wherein
the shell portion comprises calcium (Ca) in an amount of 2.5 parts by mole to 40 parts by mole based on 100 parts by mole of titanium (Ti) of the dielectric grains, and
the shell portion comprises zirconium (Zr) in an amount of 3 parts by mole to 150 parts by mole based on 100 parts by mole of titanium (Ti) of the dielectric grains.

5. The multilayer ceramic capacitor of claim 1, wherein
the shell portion comprises strontium (Sr) in an amount of 2.5 parts by mole to 40 parts by mole based on 100 parts by mole of titanium (Ti) of the dielectric grains, and
the shell portion comprises zirconium (Zr) in an amount of 3 parts by mole to 150 parts by mole based on 100 parts by mole of titanium (Ti) of the dielectric grains.

6. The multilayer ceramic capacitor of claim 1, wherein
the shell portion further comprises a rare-earth element.

7. The multilayer ceramic capacitor of claim 6, wherein
the rare-earth element comprises an element with a larger ionic radius than yttrium (Y).

8. The multilayer ceramic capacitor of claim 6, wherein
the rare-earth element comprises at least one selected from the group consisting of dysprosium (Dy), gadolinium (Gd), lanthanum (La), and cerium (Ce).

9. The multilayer ceramic capacitor of claim 6, wherein
the shell portion comprises the rare-earth element in an amount of 0.5 part by mole to 10 parts by mole based on 100 parts by mole of titanium (Ti) of the dielectric grains.

10. The multilayer ceramic capacitor of claim 1, wherein
the shell portion further comprises a transition metal.

11. The multilayer ceramic capacitor of claim 10, wherein
the transition metal comprises at least one selected from the group consisting of manganese (Mn), vanadium (V), and chromium (Cr).

12. The multilayer ceramic capacitor of claim 1, wherein
the shell portion further comprises a rare-earth element and a transition metal.

13. The multilayer ceramic capacitor of claim 1, wherein
the shell portion further comprises a rare-earth element including at least one selected from the group consisting of dysprosium (Dy), gadolinium (Gd), lanthanum (La), and cerium (Ce), and a transition metal including at least one selected from manganese (Mn), vanadium (V), and chromium (Cr).

14. The multilayer ceramic capacitor of claim 1, wherein
the dielectric layer further comprises a grain boundary disposed between the plurality of dielectric grains, and
the grain boundary comprises silicon (Si).

15. The multilayer ceramic capacitor of claim 14, wherein
the grain boundary comprises silicon (Si) in an amount of 2.5 parts by mole to 20 parts by mole based on 100 parts by mole of titanium (Ti) of the dielectric grains.

16. The multilayer ceramic capacitor of claim 14, wherein
the grain boundary further comprises a rare-earth element.

17. The multilayer ceramic capacitor of claim 16, wherein
the rare-earth element comprises at least one selected from the group consisting of dysprosium (Dy), gadolinium (Gd), lanthanum (La), and cerium (Ce).

18. The multilayer ceramic capacitor of claim 16, wherein
the grain boundary comprises the rare-earth element in an amount of 3 parts by mole to 30 parts by mole based on 100 parts by mole of titanium (Ti) of the dielectric grains.

19. The multilayer ceramic capacitor of claim 1, wherein
a diameter of the core portion is 15% to 85% of a diameter of the at least one of the plurality of dielectric grains.

20. The multilayer ceramic capacitor of claim 1, wherein
the number of dielectric grains having the core-shell structure is 5% to 100% of a total number of dielectric grains present in the dielectric layer.

21. A method of manufacturing the multilayer ceramic capacitor according to claim 1, comprising:
preparing a dielectric slurry comprising main component powder including a barium titanate-based compound and a zirconium-based compound;
manufacturing a dielectric green sheet from the dielectric slurry, and forming a conductive paste layer on a surface of the dielectric green sheet;
manufacturing a dielectric green sheet stack by stacking a plurality of the dielectric green sheets on which the conductive paste layer is formed;
manufacturing a capacitor body including a dielectric layer and an internal electrode layer by firing the dielectric green sheet stack; and
forming an external electrode on an outer surface of the capacitor body,
wherein the zirconium-based compound comprises at least one selected from the group consisting of a compound containing Zr and Ca and a compound containing Zr and Sr,
the dielectric layer comprises a plurality of dielectric grains,
at least one of the plurality of dielectric grains has a core-shell structure including a core portion and a shell portion surrounding at least a portion of the core portion,
the core portion comprises barium (Ba) and titanium (Ti), and
the shell portion comprises calcium (Ca) or strontium (Sr), and zirconium (Zr).

22. The method of claim 21, wherein
the main component powder comprises a mixture of the barium titanate-based compound and the zirconium-based compound, or a composite in which the zirconium-based compound is coated on a surface of the barium titanate-based compound.

23. The method of claim 21, wherein
the zirconium-based compound comprises at least one selected from CaZrO₃ and SrZrO₃.

24. The method of claim 21, wherein
the dielectric slurry further comprises a secondary component powder including at least one selected from the group consisting of a silicon (Si)-containing compound, a rare-earth element-containing compound, and a transition metal-containing compound.

25. The method of claim 24, wherein
the rare-earth element-containing compound comprises at least one selected from the group consisting of a dysprosium (Dy)-containing compound, a gadolinium (Gd)-containing compound, a lanthanum (La)-containing compound, and a cerium (Ce)-containing compound.

26. The method of claim 24, wherein
the transition metal-containing compound comprises at least one selected from the group consisting of a manganese (Mn)-containing compound, a vanadium (V)-containing compound, and a chromium (Cr)-containing compound.

27. The method of claim 24, wherein
the secondary component powder comprises the silicon (Si)-containing compound, the rare-earth element-containing compound, and the transition metal-containing compound.

28. The method of claim 21, wherein
the zirconium-based compound is included in an amount of 1 mol % to 20 mol % based on a total amount of the barium titanate-based compound and the zirconium-based compound.
